(19) United States
(12) Patent Application Publication
(10) Pub. No.: US 2024/0083152 A1
(43) Pub. Date: Mar. 14, 2024

(54) TRANSFER SHEET, DECORATIVE MOLDED PRODUCT, AND METHOD FOR MANUFACTURING DECORATIVE MOLDED PRODUCT

(71) Applicant: NISSHA CO., LTD., Kyoto-shi, Kyoto (JP)

(72) Inventors: Shinichi KITAMURA, Kyoto-shi (JP); Masaki KASHIWAGI, Kyoto-shi (JP); Hiroshi TASHIRO, Kyoto-shi (JP)

(21) Appl. No.: 18/551,320

(22) PCT Filed: Feb. 25, 2022
(86) PCT No.: PCT/JP2022/008011

§ 371 Date: Sep. 19, 2023

(30) Foreign Application Priority Data
Mar. 30, 2021 (JP) 2021-058476

(51) Int. Cl. B32B 27/20; B44C 1/17

(52) U.S. Cl. CPC B32B 27/20; B44C 1/17; B32B 2250/05; B32B 2264/1021; B32B 2264/301; B32B 2264/401; B32B 2333/08; B32B 2451/00

(57) ABSTRACT

A transfer sheet that can provide an anti-reflection function to a molded product without decreasing designability, a decorative molded product, and a method for manufacturing a decorative molded product are provided. A transfer sheet includes a release sheet including a base sheet and a release layer, a low refractive index layer on the release layer, a hard coat layer on the low refractive index layer, and an adhesive layer on the hard coat layer. The low refractive index layer contains an active energy ray-curable resin, hollow silica particles, and silica particles with a particle diameter 0.1 to 1.7 times a particle diameter of the hollow silica particles.

### TECHNICAL FIELD

The present invention relates to an anti-reflective transfer sheet for a decorative molded product.

### BACKGROUND

Displays (display devices) are used for various purposes in various environments. In the field of automobiles, displays are used in, for example, car navigation systems, center information displays, and meter panels to provide various items of information. As capacitive touchscreens or other devices are widespread nowadays, displays are typically operated by touching. Such displays are thus to have, for example, improved operability and touch, in addition to good appearance, and also to fit on three-dimensional shapes, rather than on two-dimensional shapes, for more sophisticated designs.

Various methods have been used for processing display surfaces to have anti-reflection to prevent glares caused by reflection of external light that can lower visibility. Examples include a lamination method for laminating a glass plate with an anti-reflection film including an adhesive layer and a dip method for dipping a glass substrate with a liquid film to form an anti-reflection layer. However, the lamination method may cause distortion resulting from the adhesive layer and degrade the high visibility of the glass. The dip method involves single-sheet fabrication that may lower productivity.

A transfer method has thus been developed for transferring an anti-reflection layer formed on a peelable support to provide the anti-reflection function. For example, Patent Literature 1 describes an anti-reflection transfer film laminated on a polymethyl methacrylate plate, from which a peelable support is then peeled. However, this technique is used for flat plates and is yet to be used for three-dimensional molded products.

Patent Literature 2 describes a technique for injection molding using a transfer member with a design or a function placed in a mold to provide the design or the function on a surface of a three-dimensional molded product. However, when an anti-reflection layer is used as a functional layer, adhesion between a release layer on a base sheet and the anti-reflection layer may be weaker, causing a part of the release layer to separate from the anti-reflection layer. The part of the release layer separate from the anti-reflection layer before molding may leave marks after a release sheet is peeled.

### CITATION LIST

### Patent Literature

Patent Literature 1: Japanese Unexamined Patent Application Publication No. 2007-114305
Patent Literature 2: Japanese Unexamined Patent Application Publication No. 9-123694

### BRIEF SUMMARY

### Technical Problem

One or more aspects of the present invention are directed to a transfer sheet that can provide the anti-reflection function to a molded product without causing loose attachment or separation between layers, a decorative molded product, and a method for manufacturing a decorative molded product.

### Solution to Problem

In response to the above, a transfer sheet according to a first aspect of the present invention includes a release sheet including a base sheet and a release layer, and a low refractive index layer on the release layer. The low refractive index layer contains an active energy ray-curable resin, (a) hollow silica particles, and (b) silica particles with a particle diameter 0.1 to 1.7 times a particle diameter of the hollow silica particles.

This structure includes silica particles with a specific particle diameter to allow appropriate adhesion between the release layer and the low refractive index layer and reduce loose attachment or separation of the release sheet without degrading an anti-reflection function.

A transfer sheet according to a second aspect of the present invention is the transfer sheet according to the first aspect of the present invention in which the low refractive index layer has a total content of 60 to 71 parts by mass of (a) and (b) in a total of 100 parts by mass of the active energy ray-curable resin, (a), and (b).

This structure further allows improved adhesion between the release layer and the low refractive index layer and prevents loose attachment or separation of the release sheet before molding to avoid leaving marks after the release sheet is peeled.

A transfer sheet according to a third aspect of the present invention is the transfer sheet according to the first aspect or the second aspect of the present invention in which the low refractive index layer has a content of 30 to 41 parts by mass of the active energy ray-curable resin, a content of 40 to 50 parts by mass of (a), and a content of 9 to 25 parts by mass of (b).

This structure can improve the scratch resistance of the low refractive index layer while maintaining the anti-reflection function and the adhesion between the release layer and the low refractive index layer.

A transfer sheet according to a fourth aspect of the present invention is the transfer sheet according to any one of the first to third aspects of the present invention in which the low refractive index layer has a film thickness of 50 to 150 nm.

This structure can further improve the anti-reflection function of the low refractive index layer.

A transfer sheet according to a fifth aspect of the present invention is the transfer sheet according to any one of the first to fourth aspects of the present invention further including a hard coat layer on the low refractive index layer.

This structure allows improved adhesion between the low refractive index layer and the hard coat layer with the surfaces of the silica particles in the low refractive index layer received in the hard coat layer, and allows the release sheet to be peeled more easily from the low refractive index layer.

A decorative molded product according to a sixth aspect of the present invention includes a molded body and a low refractive index layer on the molded body. The low refractive index layer contains an active energy ray-curable resin, (a) hollow silica particles, and (b) silica particles with a particle diameter 0.1 to 1.7 times a particle diameter of the hollow silica particles.

A method according to a seventh aspect of the present invention is a method for manufacturing a decorative molded product. The method includes preparing a transfer sheet including a release sheet including a base sheet and a release layer and including, on the release sheet, a low refractive index layer containing an active energy ray-curable resin, (a) hollow silica particles, and (b) silica particles with a particle diameter 0.1 to 1.7 times a particle diameter of the hollow silica particles, placing the transfer sheet in a first mold, closing the first mold and a second mold to define a cavity, injecting a molten resin into the cavity, cooling and solidifying the molten resin to form a molded body, and transferring the low refractive index layer onto the molded body to form a decorative molded product, opening the first mold and the second mold, and removing the decorative molded product.

This structure includes silica particles with a specific particle diameter to allow appropriate adhesion between the release layer and the low refractive index layer and reduce loose attachment or separation of the release sheet without degrading the anti-reflection function.

### Advantageous Effects

The technique according to the above aspects of the present invention provides a transfer sheet that can provide the anti-reflection function to a molded product without causing loose attachment or separation between layers, a decorative molded product, and a method for manufacturing a decorative molded product.

### BRIEF DESCRIPTION OF DRAWINGS

FIG. 1 is a cross-sectional view of a transfer sheet 10 according to an embodiment of the present invention.

FIG. 2 is a cross-sectional view of a decorative molded product 20 according to the embodiment of the present invention.

FIG. 3 is a schematic diagram of placement with a method for manufacturing the decorative molded product according to the embodiment of the present invention.

FIG. 4 is a schematic diagram of suction with the method for manufacturing the decorative molded product according to the embodiment of the present invention.

FIG. 5 is a schematic diagram of mold closing with the method for manufacturing the decorative molded product according to the embodiment of the present invention.

FIG. 6 is a schematic diagram of injection with the method for manufacturing the decorative molded product according to the embodiment of the present invention.

FIG. 7 is a schematic diagram of mold opening and removing with the method for manufacturing the decorative molded product according to the embodiment of the present invention.

### DETAILED DESCRIPTION

One or more embodiments of the present invention will now be described with reference to the drawings. A range of one value to another value herein refers to a range of values including the upper and lower limit values, unless otherwise specified. In other words, a range of one value to another value refers to a range of greater than or equal to one value to less than or equal to the other value.

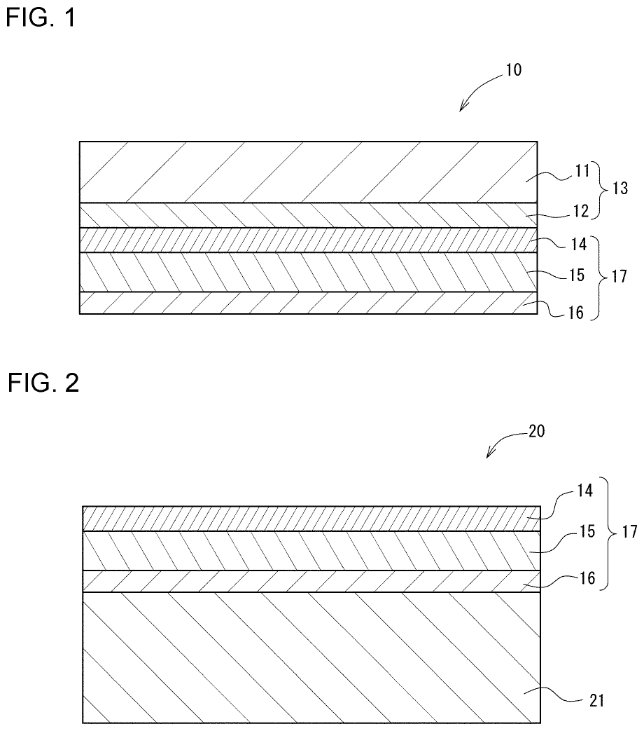

Referring to FIG. 1, a transfer sheet 10 according to the present embodiment includes a release sheet 13 including a base sheet 11 and a release layer 12, a low refractive index layer 14 on the release layer 12, a hard coat layer 15 on the low refractive index layer 14, and an adhesive layer 16 on the hard coat layer 15. The low refractive index layer 14 contains an active energy ray-curable resin, (a) hollow silica particles, and (b) silica particles with a particle diameter 0.1 to 1.7 times the particle diameter of the hollow silica particles. The low refractive index layer 14, the hard coat layer 15, and the adhesive layer 16 in the transfer sheet 10 are transfer layers 17 to be transferred onto a target object. The transfer sheet 10 is peeled at the interface between the release layer 12 and the low refractive index layer 14 after molding, and the release sheet 13 is removed.

Referring to FIG. 2, a decorative molded product 20 according to the present embodiment includes a molded body 21, the adhesive layer 16 on the molded body 21, the hard coat layer 15 on the adhesive layer 16, and the low refractive index layer 14 on the hard coat layer. The decorative molded product 20 includes the low refractive index layer 14 as its outermost layer.

### Release Sheet

The base sheet 11 in the release sheet 13 is a known sheet material used for supporting the low refractive index layer 14, the hard coat layer 15, and the adhesive layer 16. The material may be any material including a resin sheet of, for example, a polypropylene resin, a polyethylene resin, a polyamide resin, a polyester resin, a polycarbonate resin, an acrylic resin, a polyvinyl chloride resin, a cellulose acetate resin, or a fluorine resin.

The base sheet 11 may have a thickness of 5 to 500 μm. With the thickness set in this range, the base sheet 11 can have sufficient rigidity and handling performance for the transfer sheet 10 to be placed in, for example, a mold.

The release layer 12 is peeled from a molded product together with the base sheet 11 when the release sheet 13 is peeled after the transfer layers 17 are transferred onto the molded body 21. The release layer 12 allows the entire peelable surface of the release sheet 13 to be released from the low refractive index layer 14. The release layer 12 may be formed from ink or paint being a composition containing an organic solvent and a heat curable resin as a binder. Examples of the heat curable resin include a resin composition containing 5 to 40 wt % of a resin obtained by addition condensation of formaldehyde to non-drying oil-modified alkyds having amino groups such as urea, melamine, guanamine, or aniline, a resin obtained by co-condensation reaction of a mixture of melamine and urea with formaldehyde, or a resin being a mixture of an epoxy resin and a melamine resin. For three-dimensional moldability to follow the complex shape of the molded product in particular, an acrylic-melamine resin may be used. For improved peelability, the release layer may have a surface free energy of greater than or equal to 40 mJ/m². The surface free energy is calculated by measuring the contact angles on the surface of the release layer with water and diiodomethane, and using the theoretical equation of Owens and Wendt based on the measured contact angles. The contact angles may be measured in accordance with JIS R3257 using a contact angle meter (DM500 manufactured by Kyowa Interface Science Co., Ltd.).

The release layer 12 may have a thickness of 0.1 to 30 μm. With the thickness of the release layer set in this range, the release sheet is more easily peelable from the low refractive index layer. More specifically, the release layer may have a thickness of 0.1 to 10 μm, or still more specifically, 0.1 to 1 μm.

### Low Refractive Index Layer

The low refractive index layer 14 allows the molded body 21 to have an anti-reflection function. The low refractive index layer 14 may be designed as appropriate for target appearance, physical properties, and cost. For the release sheet 13 to be peeled, the low refractive index layer 14 is to have the composition designed to appropriately adhere to the release layer 12 at the interface and be appropriately peeled from the release layer 12.

The low refractive index layer 14 is formed by drying and curing a resin composition L for the low refractive index layer. The low refractive index layer is to have, after curing, a film thickness set in the range of 50 to 150 nm to minimize the minimum reflectance in an intended wavelength region. With the thickness of the low refractive index layer in the above range, the low refractive index layer is used appropriately without a high minimum reflectance.

The low refractive index layer 14 may have a reflectance of 0.5 to 2.0%. With the reflectance in this range, the low refractive index layer 14 allows a decorative molded product to have the anti-reflection function. The reflectance herein is measured using a spectrophotometer (CM-5 manufactured by Konica Minolta, Inc.) and the specular component included (SCI) method at a wavelength of 550 nm on the surface of the decorative molded product (surface of the low refractive index layer) after molding, after a hiding layer is formed to include three layers of black ink printed under the low refractive index layer and the hard coat layer in the transfer sheet.

The resin composition (L) for the low refractive index layer contains hollow silica particles (hereafter referred to as hollow silica particles (a)) and silica particles with a particle diameter 0.1 to 1.7 times the particle diameter of the hollow silica particles (hereafter referred to as silica particles (b)). When the resin composition (L) for the low refractive index layer contains the silica particles (b) in addition to the hollow silica particles (a), the surfaces of the silica particles (b) are partially received in the layers adjacent to the low refractive index layer. This improves the adhesion between the low refractive index layer and the adjacent layers.

The resin composition L for the low refractive index layer contains an active energy ray-curable resin for retaining the hollow silica particles (a) and the silica particles (b) in the low refractive index layer and can further contain other components. Examples of such other components include a photoinitiator, a metal oxide, a photosensitizer, a stabilizer, an ultraviolet absorber, an infrared absorber, an antioxidant, a leveling agent, an adhesion improver, and an antifoulant.

The silica particles (b) have an average particle diameter 0.1 to 1.7 times the particle diameter of the average particle diameter of the hollow silica particles (a). When the silica particles (b) have an average particle diameter greater than or equal to 0.1 times the average particle diameter of the hollow silica particles (a), the surfaces of the silica particles (b) can be easily received in the release layer or the hard coat layer adjacent to the low refractive index layer, improving the adhesion between the low refractive index layer and the release layer or the hard coat layer. When the silica particles (b) have an average particle diameter less than or equal to 1.7 times the average particle diameter of the hollow silica particles (a), the average particle diameter of the silica particles (b) does not cause an increase in diffused light and maintains the anti-reflection function.

The low refractive index layer 14 may be adjusted to have a refractive index of 1.3 to 1.45 as appropriate for the relative relationship between the hollow silica particles (a), the silica particles (b), and the active energy ray-curable resin. The refractive index herein can be measured in accordance with JIS K0062-1992 using an Abbe refractometer.

For the amount of each component in the above composition, the low refractive index layer 14 may contain 40 to 50 parts by mass of the hollow silica particles (a), 9 to 25 parts by mass of the silica particles (b), and 30 to 41 parts by mass of the active energy ray-curable resin in a total solid content of 100 parts by mass of the hollow silica particles (a), the silica particles (b), and the active energy ray-curable resin. With the above amount of each component, the contents of the hollow silica particles (a) and the silica particles (b) are appropriate for the amount of the active energy ray-curable resin. This maintains the anti-reflection function with the hollow silica particles (a) and the adhesion to the adjacent layers with the silica particles (b), and improves the scratch resistance of the low refractive index layer.

The hollow silica particles (a) used in the low refractive index layer 14 may have a refractive index of 1.2 to 1.4. With the refractive index of the hollow silica particles (a) set in this range, the low refractive index layer 14 can have the anti-reflection function and an appropriate coating film strength with the appropriate content of the hollow silica particles.

The hollow silica particles (a) may have an average particle size of less than or equal to about 60 nm. With the average particle diameter set to less than or equal to about 60 nm, the size of the hollow silica particles does not cause an increase in diffused light and maintains the anti-reflection function appropriately.

The hollow silica particles (a) may have their surfaces modified with, for example, a silane coupling agent having (meth)acryloyl groups. When the hollow silica particles have their surfaces modified with, for example, a silane coupling agent having (meth)acryloyl groups, covalent bonds are formed with the active energy ray-curable resin and are likely to increase the coating film strength. Further, when the low refractive index layer 14 contains more hollow silica particles (a), covalent bonds are formed between the (meth)acryloyl groups modified on the surfaces of the hollow silica particles and the active energy ray-curable resin contained in the hard coat layer at the interface between the low refractive index layer and the hard coat layer in contact with the low refractive index layer. This improves the interfacial adhesion.

The low refractive index layer 14 may contain a total content of 60 to 71 parts by mass of the hollow silica particles (a) and the silica particles (b) in a total solid content of 100 parts by mass of the hollow silica particles (a), the silica particles (b), and the active energy ray-curable resin. With the amount of the hollow silica particles (a) and the silica particles (b) set in this range, the adhesion between the low refractive index layer and the adjacent release layer or the adjacent hard coat layer can be maintained. With improved adhesion between the low refractive index layer and the release layer in particular, the structure prevents loose attachment or separation of the release sheet before molding to avoid leaving marks after the release sheet is peeled.

Examples of the active energy ray-curable resin include an ultraviolet curable resin and an electron beam curable resin that cure through, for example, cross-linking reactions with irradiation of ultraviolet rays or electron beams. More specifically, the active energy ray-curable resin may be a monomer, an oligomer, or a polymer with ethylenically unsaturated double bonds such as vinyl groups or (meth)acryloyl groups.

Further, the active energy ray-curable resin may be an acrylate compound, a urethane acrylate compound, or an epoxy acrylate compound. A monofunctional compound or a multifunctional compound may be selected as appropriate. To have a low refractive index in particular, the active energy ray-curable resin may be an acrylate compound, a urethane acrylate compound, or an epoxy acrylate compound containing fluorine.

Examples of the photoinitiator used in the low refractive index layer include a photo-radical polymerization initiator. A photo-radical polymerization initiator can reduce the reaction time and is appropriate for roll-to-roll fabrication compared with a photo-cationic polymerization initiator or a photo-anionic polymerization initiator. The low refractive index layer 14 normally contains 1 to 10 parts by mass of the photoinitiator in a total solid content of 100 parts by mass of the hollow silica particles (a), the silica particles (b), and the active energy ray-curable resin. The low refractive index layer 14 may contain 2 to 8 parts by mass of the photoinitiator. With the amount of the photoinitiator in this range, the low refractive index layer is used appropriately without a curing failure or a refractive index being too high.

Examples of the photo-radical polymerization initiator include a benzoin or a benzoin alkyl ether such as a benzoin and a benzoin methyl ether, an aromatic ketone such as a benzophenone and a benzoylbenzoic acid, a benzyl ketal such as a benzyl dimethyl ketal and a benzyl diethyl ketal, an acetophenone such as a 1-hydroxycyclohexylphenyl ketone and a 2-hydroxy-2-methyl-1-phenyl-1-propan-1-one, and an acylphosphine oxide such as 2,4,6-trimethylbenzoyldiphenyl phosphine oxide and bis(2,4,6-trimethylbenzoyl)phenyl phosphine oxide.

The resin composition (L) for the low refractive index layer may be diluted with an organic solvent to cause the system to be uniform and to facilitate coating. Examples of the organic solvent include an alcohol solvent, an aromatic hydrocarbon solvent, an ether solvent, an ester solvent, an ether ester solvent, a ketone solvent, and a phosphate solvent.

### Hard Coat Layer

The hard coat layer 15 is transparent and provides hardness to the decorative molded product. The hard coat layer 15 may be an energy curable resin that cross-links or cures when energy such as heat, ultraviolet rays, or electron beams are applied. The hard coat layer may be formed from any material, but may be an ionizing radiation curable resin such as cyanoacrylate and urethane acrylate resins, or a heat curable resin such as acrylic and urethane resins. The energy curable resin may be an active energy ray-curable resin that cross-links when ultraviolet rays or electron beams are applied. The cross-linking of the active energy ray-curable resin can be easily adjusted by increasing or decreasing the amount of energy applied. The transfer sheet may include a cured hard coat layer, an uncured hard coat layer, or a partially-cured hard coat layer. An uncured hard coat layer or a partially-cured hard coat layer can be cured after the decorative molded product is manufactured using the transfer sheet.

The hard coat layer 15 may be formed from a material such as an acrylic resin, a polyester resin, a polyvinyl chloride resin, a cellulose resin, a rubber resin, a polyurethane resin, and a polyvinyl acetate resin, and a copolymer such as a vinyl chloride-vinyl acetate copolymer resin and an ethylene-vinyl acetate copolymer resin. To have the hardness, the hard coat layer may be formed from a photocurable resin such as an ultraviolet curable resin, a radiation curable resin, and a heat curable resin. The hard coat layer may be colored or uncolored.

A photocurable resin may be a composition being a mixture of an ethylenically unsaturated oligomer and an unsaturated ethylenically monomer with additives such as a polymerization initiator and a sensitizer. Examples of an ethylenically unsaturated oligomer include polyester(meth)acrylate, urethane(meth)acrylate, epoxy(meth)acrylate, polyether(meth)acrylate, polyol(meth)acrylate, melamine(meth)acrylate, triazine acrylate, epoxy-modified(meth)acrylate, urethane-modified(meth)acrylate, and (meth)acrylic-modified polyester.

A radiation curable resin may be a resin with one or more ethylenically unsaturated double bonds in its molecules or a resin with one or more cationic polymerizable groups such as epoxy groups in its molecules. Examples of a resin with one or more ethylenically unsaturated double bonds in its molecules include an unsaturated polyester resin, a polyester polyacrylate resin, a polyester polymethacrylate resin, an epoxy polyacrylate resin, an epoxy polymethacrylate resin, a urethane polyacrylate resin, a urethane polymethacrylate resin, an acrylic polyacrylate resin, and an acrylic polymethacrylate resin.

A heat curable resin may be an unsaturated polyester resin, a melamine resin, an epoxy resin, or a urethane resin. The heat curable resin includes a resin that cures at an ordinary temperature.

The hard coat layer 15 may be formed from an active energy ray-curable resin such as a heat and active energy ray-curable resin described in WO 97/040990. The aforementioned International Publication describes the heat and active energy ray-curable resin composition containing, as active components, a polymer with the (meth)acrylic equivalent being 100 to 300 g/eq, the hydroxyl group value being 20 to 500, and the weight average molecular weight being 5,000 to 50,000, and multifunctional isocyanate.

A specific example of the above polymer may be obtained through the reaction of a polymer having glycidyl groups with α,β-unsaturated carboxylic acids such as an acrylic acid. Specific examples of multifunctional isocyanate include a trimer of diisocyanate such as 1,6-hexanediisocyanate.

A heat and active energy ray-curable resin, when heated, partially cross-links and loses fluidity, but does not fully cross-link and remains flexible. The transfer sheet including the hard coat layer thus can follow the surface of the molded body with a complex three-dimensional shape to manufacture the decorative molded product described later.

The hard coat layer 15 is formed with a coating method such as gravure coating, roll coating, comma coating, and lip coating, or a printing method such as gravure printing and screen printing.

The hard coat layer 15 may have a thickness of 1 to 30 μm, or more specifically, 1 to 25 μm, or still more specifically, 1 to 20 μm. With the thickness of the hard coat layer set in this range, the hard coat layer has a sufficient hardness on its surface, allowing the surface of the molded product to maintain the protective function.

When the hard coat layer 15 contains the active energy ray-curable resin, the above resin cross-links with irradiating active energy rays after molding the molded product. Examples of active energy rays to cause the active energy ray-curable resin to cross-link include electron beams, X-rays, ultraviolet rays, and visible light. The active energy rays may be ultraviolet rays with a wavelength of 200 to 400 nm, or more specifically, 220 to 300 nm. Examples of a source of ultraviolet rays include a high-pressure mercury lamp, an ultra-high-pressure mercury lamp, a metal halide lamp, and an electrodeless lamp. The source of ultraviolet rays may be a high-pressure mercury lamp.

### Adhesive Layer

The adhesive layer 16 is on the hard coat layer 15. The adhesive layer 16 improves the adhesion between the hard coat layer 15 and the molded body 21.

The adhesive layer 16 may be formed from any material that sufficiently adheres to the molded body 21. A thermosensitive synthetic resin or a pressure-sensitive synthetic resin may be selected as appropriate as the material for the adhesive layer.

When the molded body 21 has a surface formed from a polyacrylic resin, for example, the adhesive layer 16 may be formed from a polyacrylic resin. When the molded body 21 has a surface formed from a polyphenylene oxide copolymer, a polystyrene copolymer resin, a polycarbonate resin, a styrene resin, or a polystyrene blend resin, for example, a polyacrylic resin, a polystyrene resin, or a polyamide resin that has affinity with the resins described above may be selected as appropriate as the material for the adhesive layer 16. When the molded body 21 has a surface formed from a polypropylene resin, for example, a chlorinated polyolefin resin, a chlorinated ethylene-vinyl acetate copolymer resin, a cyclized rubber, or a coumarone indene resin may be used as the material for the adhesive layer 16.

The adhesive layer 16 may have a thickness of 0.1 to 10 μm, or more specifically, 0.5 to 7 μm, or still more specifically, 1 to 5 μm. With the thickness set in this range, the adhesive layer 16 can maintain the adhesion between the molded body and the transfer layer and allows, when the transfer sheet is heated, heat to be transferred to each layer, thus allowing each layer to be sufficiently soft and reducing cracks.

The transfer sheet 10 may include a hiding layer, a graphic layer, an anchor layer, and a thin metal film as appropriate.

For example, the hiding layer hides the base color of the molded body to enhance the design of the decorative molded product. The hiding layer is formed by, for example, applying ink or paint between the hard coat layer 15 and the adhesive layer 16.

The hiding layer may include at least one synthetic resin as a binder selected from the group consisting of a polyvinyl resin, a polyamide resin, a polyester resin, an acrylic resin, a polyurethane resin, a polyvinyl acetal resin, a polyester urethane resin, a cellulose ester resin, an alkyd resin, a vinyl chloride-vinyl acetate copolymer resin, a thermoplastic urethane resin, a methacrylic resin, an acrylic ester resin, a chlorinated rubber resin, a chlorinated polyethylene resin, and a chlorinated polypropylene resin.

Colorants used for the hiding layer may be pigments or dyes known for coloring transfer sheets. Examples of such colorants include: (1) plant pigments such as indigo, alizarin, carthamin, anthocyanins, flavonoids, and shikonin; (2) food dyes such as azo, xanthene, and triphenylmethane; (3) natural inorganic pigments such as yellow earth and green earth; (4) acrylic and urethane inorganic pigments; and (5) calcium carbonate, titanium dioxide, aluminum lake, madder lake, and cochineal lake.

The hiding layer may be formed using ink including a binder resin in which thin metal film flakes are dispersed to have a mirror-like metallic luster (hereafter referred to as high brightness ink). The ink may contain thin metal film flakes in the range of 3 to 60 parts by mass with respect to a non-volatile component in the ink. With thin metal film flakes oriented in parallel to the molded body when the ink is printed or applied, the high brightness ink using thin metal film flakes as pigments has a mirror-like metallic luster with high brightness.

The graphic layer shows letters or designs. The graphic layer contains the same components as the hiding layer and is formed with the same method as the hiding layer, except that the graphic layer is formed in a pattern as appropriate for a graphic.

### Method for Manufacturing Transfer Sheet

A method for manufacturing the transfer sheet 10 will now be described.

The release layer 12 is applied to the base sheet 11 to form the release sheet 13. The resin composition (L) for the low refractive index layer is then applied to the release sheet 13, dried as appropriate, and cured by irradiating active energy rays to form the low refractive index layer 14. A resultant laminate X includes a single low refractive index layer on the release sheet 13.

A hard coat resin composition is applied to the low refractive index layer 14 in the laminate X to form the hard coat layer 15. A resultant laminate Y includes the hard coat layer 15 on the low refractive index layer 14 in the above laminate X.

A resin composition for the adhesive layer is then applied to the hard coat layer 15 in the laminate Y and cured to form the adhesive layer 16 and obtain the transfer sheet 10.

The resin composition (L) for the low refractive index layer, the hard coat resin composition, and the resin composition for the adhesive layer may be applied with any method including any known application method such as roll coating, spin coating, dip coating, spray coating, bar coating, knife coating, die coating, ink jetting, and gravure coating.

Active energy rays include ultraviolet (UV) rays and electron beams (EB). The amount of light irradiation may be 150 to 1,000 mJ/cm 2 and can be reduced to about 100 mJ/cm 2 in a nitrogen atmosphere.

Each process for manufacturing the transfer sheet 10 may use roll-to-roll processing to greatly improve productivity. The roll-to-roll processing refers to a conveying system that feeds a long rolled film base for continuous coating, drying, curing, and laminating of the film base and winds the film base into a roll again. All the processes may be performed continuously. However, when each process has a different processing time, the film base may be fed and wound for each process as appropriate to increase productivity.

### Method for Manufacturing Decorative Molded Product

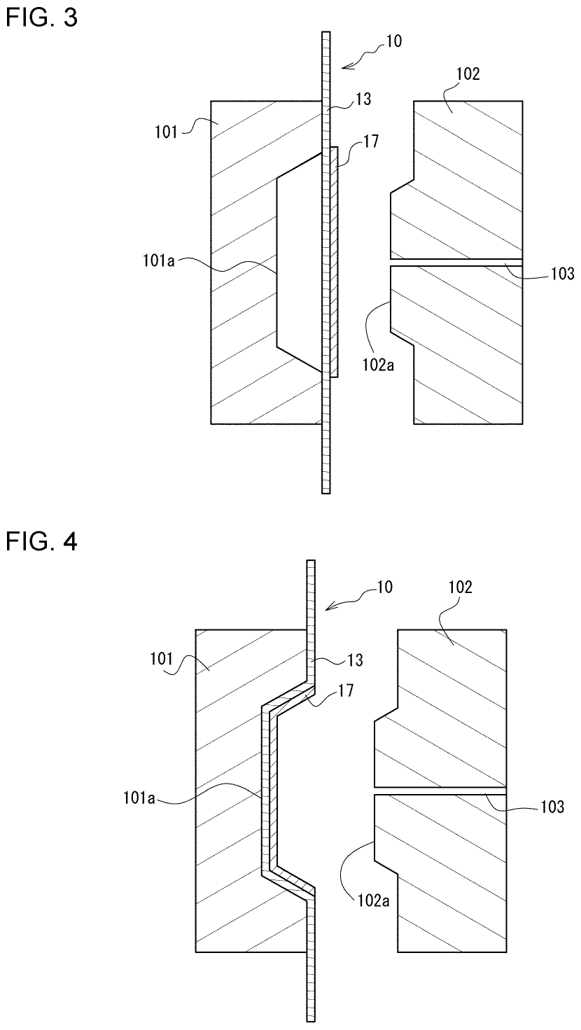

Referring to FIGS. 3 to 7, a method for manufacturing the decorative molded product 20 will now be described. The method for manufacturing the decorative molded product 20 includes preparation for preparing the transfer sheet 10, placement for placing the transfer sheet 10 on a first mold 101, mold closing for closing the first mold 101 and a second mold 102 to form a cavity S, injection for injecting a molten resin 110 into the cavity S, molding for molding the molten resin 110 into the molded body 21 by cooling and solidifying the molten resin 110 and simultaneously transferring the transfer layers 17 onto the molded body to form the decorative molded product 20, mold opening for opening the first mold 101 and the second mold 102, and removal for removing the decorative molded product 20.

The preparation includes preparing the transfer sheet 10 including the release sheet 13 including the base sheet 11 and the release layer 12, the low refractive index layer 14 on the release layer 12, the hard coat layer 15 on the low refractive index layer 14, and the adhesive layer 16 on the hard coat layer 15. The low refractive index layer 14 contains the active energy ray-curable resin, the hollow silica particles (a), and the silica particles (b) with a particle diameter 0.1 to 1.7 times the particle diameter of the hollow silica particles. The low refractive index layer 14, the hard coat layer 15, and the adhesive layer 16 in the transfer sheet 10 are the transfer layers 17 to be transferred onto the molded body 21.

Referring to FIG. 3, the first mold 101 is movable with a recess, and the second mold 102 is fixed with a protrusion. The first mold 101 and the second mold 102 form the cavity S by mold closing. The second mold 102 has a sprue 103 as a path for the molten resin. The placement includes feeding the transfer sheet 10 to a cavity surface 101a of the first mold 101 and placing the transfer sheet 10 to align the transfer layers 17 in the transfer sheet 10 with the cavity surface 101a. The transfer sheet 10 is placed to cause the base sheet 11 to face the cavity surface 101a of the first mold 101 and the adhesive layer 16 to face a cavity surface 102a of the second mold.

Referring to FIG. 4, the suction includes heating and softening the transfer sheet 10 with a heater (not shown), and suctioning the transfer sheet 10 with air from the side of the first mold 101 to place the transfer sheet 10 along the cavity surface 101a.

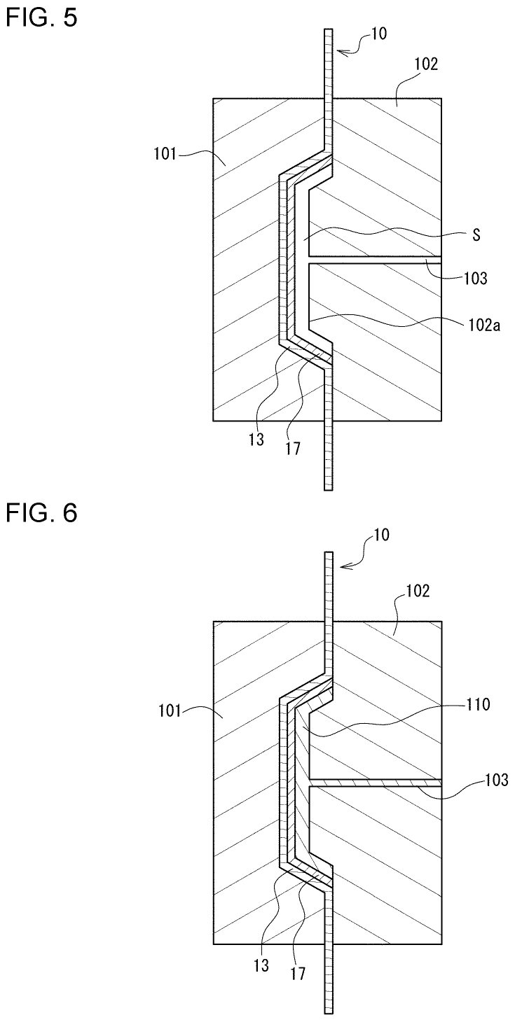

Referring to FIG. 5, the mold closing includes closing the first mold 101 and the second mold 102. This forms the cavity S between the transfer sheet 10 located along the cavity surface 101a of the first mold 101 and the cavity surface 102a of the second mold 102.

Referring to FIG. 6, the injection includes injecting the molten resin 110 into the cavity S through the sprue 103. The molten resin 110 is then cooled and solidified into the molded body 21, and the transfer layers 17 are simultaneously transferred onto the molded body 21 to form the decorative molded product 20.

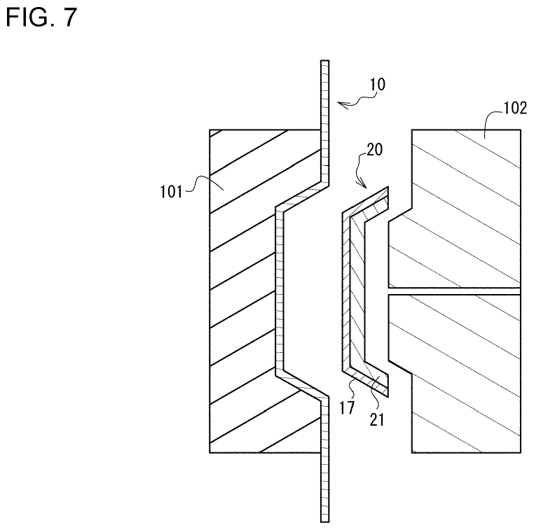

Referring to FIG. 7, the mold opening includes opening the first mold 101 and the second mold 102 and peeling the release sheet 13 from the transfer layers 17 transferred onto the molded body 21. Subsequently, the removal includes removing the decorative molded product 20 with a robot hand or other means (not shown). The decorative molded product 20 includes the molded body 21 on which the transfer layers 17 including the adhesive layer 16, the hard coat layer 15, and the low refractive index layer 14 are stacked.

When the hard coat layer 15 contains an active energy ray-curable resin, irradiation is performed to irradiate active energy rays such as ultraviolet rays to cure the hard coat layer after the decorative molded product 20 is removed.

As described above, the transfer sheet 10 according to one or more embodiments of the present invention includes the low refractive index layer 14 containing the hollow silica particles (a) and the silica particles (b). The transfer sheet 10 can thus maintain the anti-reflection function with the hollow silica particles (a) and allow the low refractive index layer 14 and the release layer 12 to adhere to each other sufficiently with the surfaces of the silica particles (b) received in the release layer 12. The transfer sheet 10 can thus maintain the anti-reflection function with the low refractive index layer 14 and reduce loose attachment or separation of the release sheet 13. The adhesion between the low refractive index layer 14 and the release layer 12 improves in particular when the low refractive index layer 14 has a total content of 60 to 71 parts by mass of the hollow silica particles (a) and the silica particles (b) in a total solid content of 100 parts by mass of the active energy ray-curable resin, the hollow silica particles (a), and the silica particles (b). This can reduce loose attachment or separation of a part of the release sheet 13 from the low refractive index layer 14 in the transfer sheet 10 before molding and prevent a decrease in designability, such as leaving marks on the surface of the molded product after molding.

With the surfaces of the silica particles (b) received in the hard coat layer 15, the adhesion between the low refractive index layer 14 and the hard coat layer 15 also improves. This allows the release layer 12 in the release sheet 13 to be more easily peeled from the low refractive index layer 14.

In the above embodiment, an in-mold transfer method is used. The method includes placing the transfer sheet in the mold and injecting the molten resin into the mold to transfer the transfer layers in the transfer sheet onto the resin. However, the transfer sheet may be used with other transfer methods. Other transfer methods include an out-mold transfer method, such as a roll transfer method and an up-down transfer method.

In the above embodiment, the transfer sheet is manufactured with roll-to-roll processing. However, the transfer sheet may be placed in the mold as a single sheet.

In the above embodiment, the transfer sheet includes the transfer layers in its portion that aligns with the cavity surface of the mold. However, the transfer sheet may include the transfer layers across its entire surface.

### EXAMPLES

The embodiment of the present invention will now be described in more detail using examples and a comparative example.

### Preparation of Resin Composition for Low Refractive Index Layer

To obtain resin compositions (L-1 to L-11) for the low refractive index layer, components with varying solid contents shown in Table 1 were mixed with one another, a photoinitiator (1-hydroxycyclohexyl-phenyl ketone, or IRGACURE 184 manufactured by Ciba Specialty Chemicals K.K.) was then added, and subsequently, methyl ethyl ketone (MEK) was mixed with each composition to obtain a coating liquid for the low refractive index layer with 5 parts by mass of the solid content concentration. The components shown in Table 1 are described below.

### Active Energy Ray-Curable Resin

α-1: Isocyanuric acid EO-modified di- and tri-acrylate (Aronix M-315 manufactured by Toagosei Co., Ltd.) Hollow Silica Particles
a-1: Silane coupling treated hollow silica particles with a particle diameter of 60 nm and a refractive index of 1.25 (Thrulya 4320 manufactured by JGC Catalysts and Chemicals Ltd.)
a-2: Silane coupling treated hollow silica particles with a particle diameter of 50 nm and a refractive index of 1.30 (Thrulya 2320 manufactured by JGC Catalysts and Chemicals Ltd.) Silica Particles
b-1: Silica particles with a particle diameter of 10 to 15 nm (IPA-ST manufactured by Nissan Chemical Corporation)
b-2: Silica particles with a particle diameter of 40 to 50 nm (IPA-ST-L manufactured by Nissan Chemical Corporation)
b-3: Silica particles with a particle diameter of 70 to 100 nm (IPA-ST-ZL manufactured by Nissan Chemical Corporation)

TABLE 1

| | | Ex- | Ex- | Ex- | Ex- | Ex- | Ex- | Ex- | Ex- | Ex- | Ex- | Ex- |
|---|---|---|---|---|---|---|---|---|---|---|---|---|
| | | ample | ample | ample | ample | ample | ample | ample | ample | ample | ample | ample |
| | | prep- | prep- | prep- | prep- | prep- | prep- | prep- | prep- | prep- | prep- | prep- |
| | | aration | aration | aration | aration | aration | aration | aration | aration | aration | aration | aration |
| | | 1-1 | 1-2 | 13 | 1-4 | 1-5 | 1-6 | 1-7 | 1-8 | 1-9 | 1-10 | 1-11 |
| Active | Component | α-1 | α-1 | α-1 | α-1 | α-1 | α-1 | α-1 | α-1 | α-1 | α-1 | α-1 |
| energy | Part by mass | 36.0 | 30.0 | 40.0 | 35.0 | 36.0 | 36.0 | 36.0 | 41.0 | 29.0 | 41.0 | 34.0 |
| ray-curable | | | | | | | | | | | | |
| resin | | | | | | | | | | | | |
| Hollow silica | Component | a-1 | a-1 | a-1 | a-1 | a-1 | a-1 | a-2 | a-1 | a-1 | a-1 | a-1 |
| particle | Part by mass | 45.0 | 50.0 | 50.0 | 40.0 | 45.0 | 45.0 | 45.0 | 40.0 | 55.0 | 50.0 | 40.0 |
| Silica particle | Component | b-1 | b-1 | b-1 | b-1 | b-2 | b-3 | b-1 | b-1 | b-1 | b-1 | b-1 |
| | Part by mass | 19.0 | 20.0 | 10.0 | 25.0 | 19.0 | 19.0 | 19.0 | 19.0 | 16.0 | 9.0 | 26.0 |
| Total amount | Part by mass | 100.0 | 100.0 | 100.0 | 100.0 | 100.0 | 100.0 | 100.0 | 100.0 | 100.0 | 100.0 | 100.0 |

| | | | | | | | | | | | |
|---|---|---|---|---|---|---|---|---|---|---|---|
| Reference numeral for | L-1 | L-2 | L-3 | L-4 | L-5 | L-6 | L-7 | L-8 | L-9 | L-10 | L-11 |
| resin composition for low | | | | | | | | | | | |
| refractive index layer | | | | | | | | | | | |

### Example 1

### Manufacturing of Transfer Sheet

A release layer with a thickness of 8 μm was formed with a gravure coater method on one entire surface of a biaxially stretching polyethylene terephthalate film with a width of 650 mm and a thickness of 38 μm. To form the release layer, ink containing a urethane acrylate resin (ultraviolet curable resin) was used. The release layer had a thickness of 0.5 μm in the dry state.

A resin composition (L-1) for the low refractive index was mixed with a photoinitiator (1-hydroxycyclohexyl-phenyl ketone, or IRGACURE184 manufactured by Ciba Specialty Chemicals K.K.), and diluted with a solvent (methyl ethyl ketone) to obtain 5 parts by mass of a coating liquid for a low refractive index layer. The coating liquid was applied to the surface of the release layer in the release sheet with a bar coater to have a film thickness of 90 nm after curing and cured by irradiating 50 mJ of ultraviolet rays with a 120 W high-pressure mercury lamp to obtain a laminate X including the low refractive index layer on the release sheet.

Subsequently, 80 parts of urethane acrylate (UV-1700B manufactured by the Nippon Synthetic Chemical Industry Co., Ltd.), 3.0 parts by weight of a photoinitiator (IRGACURE184 manufactured by Ciba Specialty Chemicals K.K.), and 100 parts of a solvent (MEK) were stirred and mixed to obtain a coating liquid for a hard coat layer. The coating liquid for the hard coat layer was then applied to the low refractive index layer in the laminate X by bar coating and dried to form a hard coat resin layer.

The resultant hard coat resin layer has a thickness of 4 μm in a dry state. The formed hard coat resin layer was then heated to 200° C. in the line to partially cross-link to obtain the hard coat layer. The resultant intermediate laminate was wound into a roll to obtain a laminate Y.

The resultant roll was set in a printing line to feed the laminate Y, and three layers of black ink were printed to form a hiding layer. After all hiding layers were dried, the entire surface of the laminate was coated with an acrylic resin having a thickness of 1 μm by gravure printing to form an adhesive layer and obtain a transfer sheet. The transfer layers including the low refractive index layer, the hard coat layer, the hiding layer, and the adhesive layer had a thickness of 15 μm.

The resultant transfer sheet was then fed into a movable mold for injection molding and placed to align with the cavity surface of the movable mold. The movable mold and a fixed mold were closed. A molten resin was injected into the cavity to obtain a molded body, and simultaneously, the transfer layers were transferred onto the surface of the molded body. The molded body was then cooled and solidified. The molded body was then opened to peel the release sheet. The removed molded product was irradiated with active energy rays to obtain a decorative molded product.

### Examples 2 to 11

Transfer sheets and decorative molded products were obtained in the same manner as in Example 1, except that the components L-2 to L-11 shown in Table 1 were used as the corresponding resin composition for the low refractive index layer.

For each of the above examples and the comparative example, the decorative molded product using the transfer sheet obtained as described above was evaluated for anti-reflectivity, designability, and scratch resistance with the methods described below. The results are shown in Table 2.

### Reflectance (SCI)

The reflectance of the surface of the decorative molded product (surface of the low refractive index layer) was measured at a wavelength of 550 nm using the spectrophotometer (CM-5 manufactured by Konica Minolta, Inc.) and the SCI method.

### Designability

The surface of the decorative molded product was visually observed for any marks resulting from loose attachment or separation of the release sheet before molding.
Good: No marks observed
Poor: Marks observed
Scratch Resistance

The surface of the low refractive index layer being the surface of the decorative molded product was rubbed ten strokes with steel wool #0000 with a load of 100 gf at a stroke width of 25 mm and a speed of 30 mm/sec. The surface of the low refractive index layer was then visually observed and evaluated based on the criteria described below. To be evaluated as maintaining scratch resistance, the surface of the low refractive index layer is to be evaluated as good or better. The steel wool was arranged to have a diameter of about 10 mm, and cut and rubbed to have a uniform surface.
Good: 0 to 10 scratches
Poor: 11 or more scratches

TABLE 2

| | Ex- | Ex- | Ex- | Ex- | Ex- | Ex- | Ex- | Ex- | Ex- | Ex- | Ex- |
|---|---|---|---|---|---|---|---|---|---|---|---|
| | ample | ample | ample | ample | ample | ample | ample | ample | ample | ample | ample |
| | 1-1 | 1-2 | 1-3 | 1-4 | 1-5 | 1-6 | 1-7 | 1-8 | 1-9 | 1-10 | 1-11 |
| Reference numeral | L-1 | L-2 | L-3 | L-4 | L-5 | L-6 | L-7 | L-8 | L-9 | L-10 | L-11 |
| for resin composition | | | | | | | | | | | |
| for low refractive index | | | | | | | | | | | |
| Reflectance | 1.5 | 1.4 | 1.4 | 1.5 | 1.4 | 1.4 | 1.5 | 1.5 | 1.3 | 1.4 | 1.5 |
| Designability | Good | Good | Good | Good | Good | Good | Good | Poor | Good | Poor | Good |
| Scratch resistance | Good | Good | Good | Good | Good | Good | Good | Good | Poor | Good | Poor |

### REFERENCE CHARACTER LIST

10 transfer sheet
11 base sheet
12 release layer
13 release sheet
14 low refractive index layer
15 hard coat layer
16 adhesive layer
17 transfer layer
20 decorative molded product
21 molded body
101 first mold
102 second mold
103 sprue
110 molten resin

1. A transfer sheet, comprising:
a release sheet including a base sheet and a release layer; and
a low refractive index layer on the release layer, the low refractive index layer containing:
an active energy ray-curable resin,
(a) hollow silica particles, and
(b) silica particles with a particle diameter 0.3 to 1.7 times a particle diameter of (a),
the low refractive index layer having a content of 30 to 40 parts by mass of the active energy ray-curable resin, a content of 40 to 50 parts by mass of (a), and a content of 10 to 25 parts by mass of (b) in a total of 100 parts by mass of the active energy ray-curable resin, (a), and (b).

2-7. (canceled)

8. The transfer sheet according to claim 1, wherein
the low refractive index layer has a total content of 60 to 70 parts by mass of (a) and (b) in a total of 100 parts by mass of the active energy ray-curable resin, (a), and (b).

9. The transfer sheet according to claim 1, further comprising:
a hard coat layer on the low refractive index layer.

10. The transfer sheet according to claim 1, wherein
(b) includes silica particles with a particle diameter 0.8 to 1.4 times a particle diameter of (a), and
(b) has a particle diameter of 40 to 100 nm.

11. A decorative molded product, comprising:
a molded body; and
a low refractive index layer on the molded body, the low refractive index layer containing:
an active energy ray-curable resin,
(a) hollow silica particles, and
(b) silica particles with a particle diameter 0.3 to 1.7 times a particle diameter of (a),
the low refractive index layer having a content of 30 to 40 parts by mass of the active energy ray-curable resin, a content of 40 to 50 parts by mass of (a), and a content of 10 to 25 parts by mass of (b) in a total of 100 parts by mass of the active energy ray-curable resin, (a), and (b).

12. A method for manufacturing a decorative molded product, the method comprising:
preparing the transfer sheet according to claim 1;
placing the transfer sheet in a first mold;
closing the first mold and a second mold to define a cavity;
injecting a molten resin into the cavity;
cooling and solidifying the molten resin to form a molded body, and transferring the low refractive index layer onto the molded body to form a decorative molded product;
opening the first mold and the second mold; and
removing the decorative molded product.
